(19) United States
(12) Patent Application Publication
(10) Pub. No.: US 2017/0278058 A1
(43) Pub. Date: Sep. 28, 2017

(54) ITEM MANAGEMENT SYSTEM AND ITEM MANAGEMENT METHOD

(71) Applicants: BOE TECHNOLOGY GROUP CO., LTD., Beijing (CN); BEIJING BOE MULTIMEDIA TECHNOLOGY CO., LTD., Beijing (CN)

(72) Inventor: Li Zhang, Beijing (CN)

(21) Appl. No.: 15/510,937

(22) PCT Filed: Jan. 5, 2016
(86) PCT No.: PCT/CN2016/070100

§ 371 Date: Mar. 13, 2017

(30) Foreign Application Priority Data
Aug. 19, 2015 (CN) 201510512990.1

(51) Int. Cl. G06Q 10/08

(52) U.S. Cl. CPC G06Q 10/087

(57) ABSTRACT

The present disclosure proposes an item management device and an item management method. The item management device includes a master management unit and one or more slave management units. Each of the one or more slave management units is provided on a corresponding item, so as to uniquely identify the corresponding item. The master management unit is configured to record information for the respective slave management units and/or information for the items corresponding to the respective slave management units.

### CROSS-REFERENCE TO RELATED APPLICATION(S)

This application is a U.S. National Phase Application of International Application No. PCT/CN2016/070100, filed on Jan. 5, 2016, entitled “ITEM MANAGEMENT SYSTEM AND ITEM MANAGEMENT METHOD”, which claims priority to Chinese application No. 201510512990.1, filed on Aug. 19, 2015, entitled “ITEM MANAGEMENT SYSTEM AND ITEM MANAGEMENT METHOD”, both of which are incorporated herein by reference in their entireties.

### TECHNICAL FIELD

The present disclosure relates to the field of information management, and in particular, to an item management device and an item management method.

### BACKGROUND

With improvement of people's living level and quality, there are more and more items, such as household items, kitchen supplies, toilet supplies etc., in a house, and accordingly there are more and more items which are temporarily not used and are thus stored. If storage locations of those items are relatively messy, the stored items are not easy to be found, so that the items may have been expired or deteriorated when they are found, resulting in a serious waste of living resources.

How to reasonably manage items and find an item in time when the item is to be used has become a problem to be solved.

### SUMMARY

In order to at least partially solve or alleviate the above problem, the present disclosure provides an item management device and an item management method.

According to one aspect of the present disclosure, an item management device is provided, comprising a master management unit and one or more slave management units. Each of the one or more slave management units is provided on a corresponding item, so as to uniquely identify the corresponding item. The master management unit is configured to record information for the respective slave management units and/or information for the items corresponding to the respective slave management units.

According to an embodiment of the present disclosure, each of the one or more slave management units may comprise a communication module, a processing module, a prompt module, a power supply module, and an identification code for uniquely identifying the corresponding item, the communication module uniquely corresponding to the identification code. The master management unit may comprise a transmission module configured to transmit a search instruction which comprises identification code of a slave management unit corresponding to an item to be searched. The processing module may be enabled after the communication module of the slave management unit receives the search instruction, and may control the prompt module to send a prompt signal after being enabled.

According to an embodiment of the present disclosure, the prompt module may use a sound signal prompt element, a light signal prompt element, or a sound and light signal prompt element.

According to an embodiment of the present disclosure, the slave management unit may further comprise: a detection module, configured to detect an environmental parameter of an environment where the item corresponding to the slave management unit is located, and transmit the detected environmental parameter to the processing module of the slave management unit; the processing module determines whether the detected environmental parameter exceeds a warning value; and when the detected environmental parameter exceeds the warning value, the communication module of the slave management unit transmits a maintenance prompt signal to the master management unit. The master management unit may further comprise a reception module and a display module; and after the reception module receives the maintenance prompt signal, the display module is enabled to display maintenance prompt information corresponding to the maintenance prompt signal.

According to an embodiment of the present disclosure, the environmental parameter may comprise a temperature parameter, a humidity parameter and/or an atmospheric pressure parameter.

According to an embodiment of the present disclosure, the master management unit may further comprise: a recording module configured to record the identification codes of the slave management units and/or specific information for the items corresponding to the slave management units; and a storage module configured to store the identification code and/or the specific information, wherein the specific information comprises a picture, a name, a brand, a model number, a color and/or an expiration date of an item.

According to an embodiment of the present disclosure, the master management unit may further comprise a classification module, configured to classify the identification code and/or the specific information recorded by the recording module in a predefined way.

According to an embodiment of the present disclosure, the master management unit may further comprise: an input module, configured to input the specific information of the item to be searched; and a retrieval module, configured to retrieve the identification code of the slave management unit corresponding to the item to be searched from the storage module, based on the input specific information.

According to another aspect of the present disclosure, an item management method is provided, comprising: providing each of one or more slave management units on a corresponding item, so as to uniquely identify the corresponding item, and recording, by the master management unit, information of the respective slave management units and/or information for the items corresponding to the respective slave management units.

According to an embodiment of the present disclosure, the master management unit may transmit a search instruction which comprises identification code of a slave management unit corresponding to an item to be searched, and the slave management unit may send a prompt signal after receiving the search instruction.

According to an embodiment of the present disclosure, the item management method may further comprise: detecting, by the slave management unit, an environmental parameter of an environment where the item corresponding to the slave management unit is located; determining whether the detected environmental parameter exceeds a warning value;

and transmitting a maintenance prompt signal to the master management unit, when the detected environmental parameter exceeds the warning value; and displaying, by the master management unit, maintenance prompt information corresponding to the maintenance prompt signal after the maintenance prompt signal is received by the master management unit.

### BRIEF DESCRIPTION OF THE DRAWINGS

In order to illustrate the technical solutions of embodiments of the present disclosure more clearly, various embodiments of the present disclosure will be described in detail below with reference to the accompanying drawings. It is to be understood that the following description is only for the purpose of illustrating the embodiments of the present disclosure but is not intended to limit the scope of the present disclosure. It will be appreciated by the skilled in the art that various modifications and changes can be made on the various embodiments without departing from the scope of the present disclosure. In the illustrated drawings,

FIG. 1 is an exemplary schematic block diagram of an example item management device according to an embodiment of the present disclosure.

### DETAILED DESCRIPTION

Hereinafter, the item management device and the item management method provided by the present disclosure will be described in detail in connection with the drawings and the detailed description, in order for the skilled in the art to understand the technical solutions of the present disclosure better.

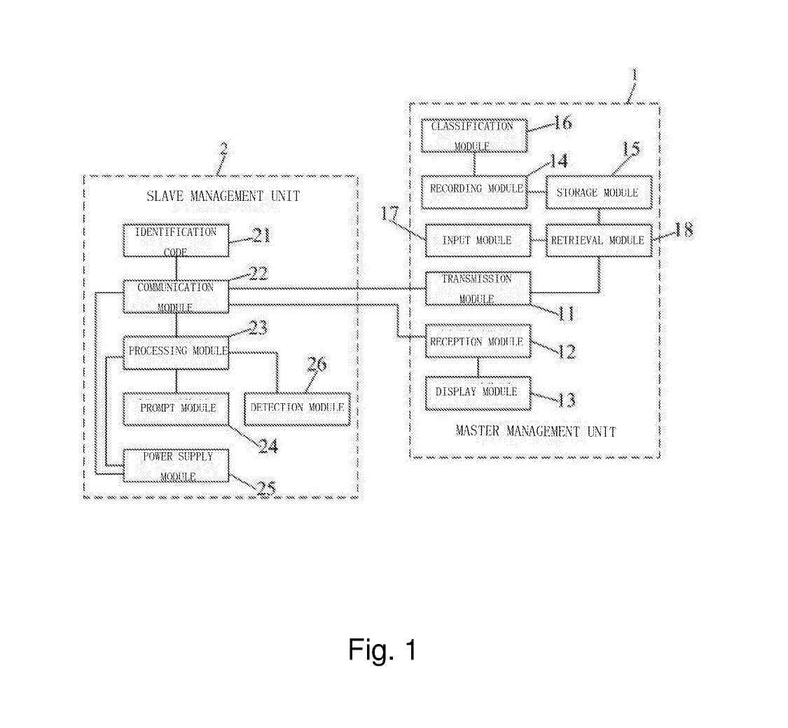

FIG. 1 shows a schematic block diagram of an item management device according to an embodiment of the present disclosure.

As shown in FIG. 1, the item management device according to the embodiment of the present disclosure may comprise a master management unit 1 and one or more slave management units 2 (although only one is shown in FIG. 1). Each slave management unit 2 of the one or more slave management units 2 may be provided on a corresponding item, so as to uniquely identify the corresponding item. Information for the respective slave management units 2 and/or information for the items corresponding to the respective slave management units 2 may be recorded by the master management unit 1. In addition, in some embodiments, the master management unit 1 may further transmit an instruction of searching for the items corresponding to one or more specific slave management units 2.

According to an embodiment of the present disclosure, the slave management unit 2 may comprise an identification code 21 for uniquely identifying the corresponding item, a communication module 22, a processing module 23, a prompt module 24, and/or a power supply module 25. The communication module 22 may correspond to the identification code 21 uniquely. The power supply module 25 may supply power to the communication module 22, the processing module 23, and the prompt module 24. The master management unit 1 may comprise a transmission module 11 for transmitting a search instruction which includes identification code 21 of a slave management unit 2 corresponding to an item to be searched. The processing module 23 may be enabled after the communication module 22 of the slave management unit 2 receives the search instruction. The processing module 23 may control the prompt module 24 to send a prompt signal after being enabled.

The slave management units 2 may be made into electronic labels for attaching to different items. The identification code 21 for uniquely identifying the item may be provided as a bar code or a QR (Quick Response) code. The communication module 22, the processing module 23, the prompt module 24, and the power supply module 25 may all be provided on the electronic label.

The communication module 22 may utilize e.g. Zigbee wireless communication technology. The Zigbee wireless communication technology is a wireless communication technology with lower power consumption and lower cost, and is suitable to be used for bi-directional wireless communication within a short range. However, the present disclosure is not limited thereto. Actually, the communication module 22 may utilize other wireless communication technology, including, but not limited to, Bluetooth, Z-Wave, Wi-Fi, RFID etc. The processing module 23 may use, e.g., a micro-processing chip. The power supply module 25 may use e.g. a paper battery, which may have a service life of about two years.

“Communication module uniquely corresponds to identification code” as described herein means that the communication module 22 of each slave management unit 2 only receives a search instruction including the identification code 21 of the slave management unit 2. When the communication module 22 of the slave management unit 2 receives the search instruction including the identification code 21 of the slave management unit 2, the processing module 23 of the slave management unit 2 is enabled. The processing module 23 controls the prompt module 24 to send the prompt signal after being enabled. Thus, the user may find the location of the item to be searched, so as to facilitate him/her to find the stored item rapidly.

According to an embodiment of the present disclosure, the prompt module 24 may use a sound signal prompt element, a light signal prompt element, or a sound and light signal prompt element. The sound signal prompt element may emit a sound prompt signal, the light signal prompt element may emit a light signal prompt signal, and the sound and light signal prompt element may emit a sound and light signal prompt signal. These prompt elements may all help people in finding an item to be searched.

According to an embodiment of the present disclosure, the slave management unit 2 may further comprise a detection module 26 configured to detect an environmental parameter of an environment where the item corresponding to the slave management unit 2 is located, and transmit the detected environmental parameter to the processing module 23 of the slave management unit 2. The processing module 23 may determine whether the detected environmental parameter exceeds a warning value; and when the detected environmental parameter exceeds the warning value, the communication module 22 of the slave management unit 2 may transmit a maintenance prompt signal to the master management unit 1. The master management unit 1 may comprises a reception module 12 and a display module 13. After the reception module 12 receives the maintenance prompt signal, the display module 13 is enabled to display maintenance prompt information corresponding to the maintenance prompt signal. According to the present embodiment, the slave management unit 2 and the master management unit 1 may maintain the storage process of the items to prevent the items from becoming moldy or damaged during storage, thereby reducing waste of item resources.

According to an embodiment of the present disclosure, the environmental parameter may include a temperature parameter, a humidity parameter and/or an atmospheric pressure parameter. According to the present embodiment, the detection module 26 may employ e.g. a sensor which is provided on the label. There may be one or more sensors provided for respectively detecting the temperature, humidity, and/or atmospheric pressure of the environment where the item is located, and for transmitting detection results to the processing module 23. When the processing module 23 determines that any one or more of the temperature, humidity and atmospheric pressure exceed the warning value(s), the communication module may transmit the maintenance prompt signal to the master management unit 1. The display module 13 may display the maintain prompt information corresponding to the maintenance prompt signal with e.g. a display, so that the people may perform maintenance and/or processing on the item in time, e.g., changing its storage position or appropriately adjusting the environment where the item is stored, etc.

According to an embodiment of the present disclosure, the master management unit 1 may further comprises a recording module 14 and a storage module 15. The recording module 14 is configured to record the identification codes 21 of the slave management units 2 and/or specific information for the items corresponding to the slave management units 2. The storage module 15 is configured to store the identification codes 21 and/or the specific information. Specific information of an item may include, but not limited to, a picture, a name, a brand, a model number, a color and/or an expiration date of the item. The more the specific information for the items is recorded and stored by the master management unit 1, the easier it is for the master management unit 1 to retrieve a certain item before transmitting a search instruction for the item, and at the same time, it is more beneficial for the master management unit 1 to manage the items. Additionally, although the specific information for the item facilitates the user in rapidly retrieving the item he/she needs when he/she uses the master management unit 1, it is not mandatory. Actually, the user may issue an instruction and find the corresponding item, as long as he can remember the identification code of the item to be searched.

The recording module 14 may comprise a scan camera, which may record the identification code 21 by scanning, and store the recorded identification code 21 directly in the storage module 15, thereby expediting recording and management of the items by the master management unit 1 significantly.

According to an embodiment of the present disclosure, the master management unit 1 may further comprise a classification module 16 configured to classify the identification codes 21 and/or the specific information recorded by the recording module 14 in a predefined manner. That is, the identification codes 21 and the specific information of various items may be, as a whole, used as the information for the items in recording, storing and classifying the items. A more specific and detailed classification of the items may be performed in accordance with a certain entry (such as the model number, the brand or the expiration date) or several entries (such as the brand and the model number, or the model number and the expiration date) of the specific information for the items. The classification module 16 may enable the master management module 1 to manage the items more effectively, and may also enable the master management module 1 to retrieve some specific item more effectively and rapidly before transmitting the instruction of searching for the item, so that the item can be retrieved rapidly.

According to an embodiment of the present disclosure, the master management unit 1 may further comprise an input module 17 and a retrieval module 18. The input module 17 is configured to input specific information for an item to be searched. The retrieval module 18 is configured to retrieve the identification code 21 of the slave management unit 2 corresponding to the item to be searched from the storage module 15, according to the input specific information.

The input module 17 may use e.g. a keyboard or a touch screen. The retrieval module 18 may search the storage module 15 for an item which complies with the input specific information, and transmit the identification code 21 of the slave management unit corresponding to the item to the transmission module 11, so that the transmission module 11 transmits the search instruction including the identification code 21 to the slave management unit 2, thereby improving searching efficiency of the item.

The item management device according to the present disclosure may be applied in items in various different environments, including, but not limited to, items in a home, medicines in a hospital pharmacy, stocks in a warehouse, or goods in a supermarket. That is, the item management device according to the present disclosure is adapted to manage items in the home, medicines in the hospital pharmacy, stocks in the warehouse, or goods in the supermarket.

It should be noted that the item management device according to the present disclosure is not limited to be used for item management in the sites as described above, but may be applied in any site which needs item management.

By providing the master management unit and the slave management unit, the item management device according to the present disclosure is convenient for item management, and enables the people to find the stored items rapidly, not only making people's lives more convenient, but also reducing the waste of life resources.

According to another aspect of the present disclosure, an item management method is provided, comprising: providing a plurality of slave management units respectively on different items, so as to uniquely identify the item corresponding to the slave management unit; recording, by the master management unit, information for the respective slave management units and/or information for the items corresponding to the respective slave management units; and transmitting, by the master management unit, an instruction of searching for the item corresponding to the slave management unit.

According to an embodiment of the present disclosure, the master management unit may transmit a search instruction which includes the identification code of the slave management unit corresponding to the item to be searched, and the slave management unit may issue a prompt signal after receiving the search instruction. As such, the item to be searched may be found rapidly, so that the people may store and manage the items more conveniently.

The item management method according to an embodiment of the present disclosure may further comprise: detecting, by the slave management unit, an environmental parameter of an environment where the item corresponding to the slave management unit is located; determining whether the detected environmental parameter exceeds a warning value; and transmitting a maintenance prompt signal to the master management unit, when the detected environmental parameter exceeds the warning value; and receiving, by the master management unit, the maintenance prompt signal, and then displaying maintenance prompt information corresponding to the maintenance prompt signal. By co-maintenance of the slave management unit and the mater management unit on the items, the items may be prevented from becoming moldy or damaged during storage, thereby reducing the waste of the item resources.

It should be noted that the functions which are described herein as being implemented by only hardware, only software and/or firmware may also be implemented by specific-purpose hardware, general-purpose hardware in combination with software etc. For example, the functions which are described as being implemented by specific-purpose hardware (e.g., field programmable gate array (FPGA), application specific integrated circuit (ASIC), etc.) may be implemented by general-purpose hardware (e.g., a central processing unit (CPU), a digital signal processor (DSP)) in combination with software, and vice versa.

It may be understood that the above implementations are only exemplary implementations for illustrating the principles of the present disclosure, but the present disclosure is not limited to these. For the skilled in the art, various variations and improvements may be made without being apart from the spirit and substance of the present disclosure, which also fall into the protection scope of the present disclosure.

1. An item management device, comprising:
a master management unit; and
one or more slave management units,
wherein each of the one or more slave management units is provided on a corresponding item, so as to uniquely identify each corresponding item, and
wherein the master management unit is configured to record information for the respective slave management units and/or information for the items corresponding to the respective slave management units.

2. The item management device according to claim 1,
wherein each of the one or more slave management units comprises a communication module, a processing module, a prompt module, a power supply module, and an identification code for uniquely identifying the corresponding item, the communication module uniquely corresponding to the identification code,
wherein the master management unit comprises a transmission module configured to transmit a search instruction which comprises identification code of a slave management unit corresponding to an item to be searched; and
wherein the processing module is enabled after the communication module of the slave management unit receives the search instruction, and after enabled the processing module controls the prompt module to send a prompt signal.

3. The item management device according to claim 2, wherein the prompt module uses a sound signal prompt element, a light signal prompt element, or a sound and light signal prompt element.

4. The item management device according to claim 2, wherein the slave management unit further comprises:
a detection module configured to detect an environmental parameter of an environment where the item corresponding to the slave management unit is located, and transmit the detected environmental parameter to the processing module of the slave management unit, wherein the processing module determines whether the detected environmental parameter exceeds a warning value; and when the detected environmental parameter exceeds the warning value, the communication module of the slave management unit transmits a maintenance prompt signal to the master management unit; and
wherein the master management unit further comprises a reception module and a display module, wherein after the reception module receives the maintenance prompt signal, the display module is enabled to display maintenance prompt information corresponding to the maintenance prompt signal.

5. The item management device according to claim 4, wherein the environmental parameter comprises a temperature parameter, a humidity parameter, and/or an atmospheric pressure parameter.

6. The item management device according to claim 2, wherein the master management unit further comprises:
a recording module configured to record the identification codes of the slave management units and/or specific information for the items corresponding to the slave management units; and
a storage module configured to store the identification code and/or the specific information, wherein the specific information comprises a picture, a name, a brand, a model number, a color, and/or an expiration date of an item.

7. The item management device according to claim 6, wherein the master management unit further comprises:
a classification module configured to classify the identification code and/or the specific information recorded by the recording module in a predefined manner.

8. The item management device according to claim 6, wherein the master management unit further comprises:
an input module configured to input the specific information of the item to be searched; and
a retrieval module configured to retrieve the identification code of the slave management unit corresponding to the item to be searched from the storage module, based on the input specific information.

9. An item management method, comprising:
providing each of one or more slave management units on a corresponding item, so as to uniquely identify each corresponding item, and
recording, by the master management unit, information for the respective slave management units and/or information for the items corresponding to the respective slave management units.

10. The item management method according to claim 9, wherein the master management unit transmits a search instruction which comprises identification code of a slave management unit corresponding to an item to be searched, and the slave management unit, after receiving the search instruction, sends a prompt signal.

11. The item management method according to claim 10, further comprising:
detecting, by the slave management unit, an environmental parameter of an environment where the item corresponding to the slave management unit is located; determining whether the detected environmental parameter exceeds a warning value; and transmitting a maintenance prompt signal to the master management unit when the detected environmental parameter exceeds the warning value; and
displaying, by the master management unit, maintenance prompt information corresponding to the maintenance prompt signal after the maintenance prompt signal is received by the master management unit.
